(19) United States
(12) Patent Application Publication
(10) Pub. No.: US 2008/0030753 A1
(43) Pub. Date: Feb. 7, 2008

(54) Image compensating system, method and medium

(75) Inventors: Moon-sik Jeong, Yongin-si (KR); Yong-beom Lee, Yongin-si (KR); Tae-suh Park, Yongin-si (KR); Jong-il Park, Yongin-si (KR); Han-Hoon Park, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/713,673

(22) Filed: Mar. 5, 2007

(30) Foreign Application Priority Data
Aug. 1, 2006 (KR) 10-2006-0072773

(51) Int. Cl. G06K 9/00; H04N 1/60

(52) U.S. Cl. 358/1.9; 353/84

(57) ABSTRACT

An image compensation system, method and medium that can reduce the amount of computation required for image compensation. The system may include a storage unit to store information concerning overlapping components among color light components, a separating unit to separate the color light components of an original image by removing the overlapping components from the color light components based on the stored information, prior to performing image compensation, and a projecting unit to project the separated color light components onto a screen

### CROSS-REFERENCE TO RELATED APPLICATIONS

This application claims priority from Korean Patent Application No. 10-2006-0072773 filed on Aug. 1, 2006 in the Korean Intellectual Property Office, the disclosure of which is incorporated herein by reference in its entirety.

### BACKGROUND

1. Field

One or more embodiments of the present invention relate to an image compensating system, method and medium, and more particularly, to an image compensating system, method and medium that can reduce the amount of computation required for image compensation by capturing an image projected onto a screen, comparing the captured image to the original image, and controlling overlapping components among color light components of the captured image.

2. Description of the Related Art

Generally, in order to perform image compensation, the original image is projected onto a screen using a projector, the projected image is captured using a camera, and the captured image is compared to the original image.

Color light components of the projected image captured by the camera are compared to color light components of the original image input to the projector, and are compensated based on the comparison result. When red, green, and blue light components projected by the projector are captured using the camera, each color light component includes overlapping components, with the overlapping color light components having wavelengths adjacent to the wavelength of the corresponding color light component. For example, each of the red, green, and blue light components of an image captured by the camera partially overlaps the other color light components, as shown in FIG. 1. Therefore, even though only a primary red light component is projected by the projector, in a corresponding image captured by the camera an overlapping component V_{RG} of the red light component and the green light component, and an overlapping component V_{RB} of the red color light component and the green color light component, as well as the primary red light component V_{RR}, exist as shown in FIG. 2A. Similarly, even when only a primary green or blue light component is projected, overlapping components of the green or blue light component and the other color light components, as well as the primary green or blue light component, exist in an image captured by the camera, as shown in FIGS. 2B and 2C.

Therefore, in order to perform image compensation by comparing the captured image to the original image input to the projector, separation of the overlapping color light components is required, and thus additionally processing is required due to the overlapping components. Therefore, the amount of computation required for image compensation increases.

Further, when the image is projected onto the screen using a mobile apparatus having relatively little computing power, the additional processing due to the overlapping components increases the time required to perform the image compensation and reduces the efficiency of image compensation.

For the reason, when image compensation is performed by comparing the captured image to the original image input to the projector, a technique capable of reducing the amount of computation, and the time required to perform the image compensation is desired. Such a technique would improve the efficiency of image compensation by removing the overlapping components from the color light components.

Japanese Patent Publication No. 2005-099478 discloses a projector that has a spectrum analyzing function and compensates for outputs of light valves after capturing and decomposing the spectrum of light using an image capturing device. However, Japanese Patent Publication No. 2005-099478 does not propose a technique capable of preventing the increased processing time and reduction in efficiency caused by overlapping components among color light components.

### SUMMARY

One or more embodiments of the present invention provide an image compensating system and method capable of preventing an increase in the processing time for image compensation and a corresponding reduction in image compensating efficiency, by removing overlapping components among color light components using a projector.

One or more embodiments of the present invention provide an image compensating system and method capable of preventing an increase in processing time for image compensation and reduction in the image compensating efficiency by removing overlapping components among color light components using a camera.

Additional aspects and/or advantages of the present invention will be set forth in part in the description which follows and, in part, will be apparent from the description, or may be learned by practice of the present invention.

To achieve at least the above and/or other aspects and advantage, embodiments of the present invention include an image compensating system. The system includes a storage unit to store information concerning overlapping components among color light components, a separating unit to separate the color light components of an original image by removing the overlapping components from the color light components based on the stored information, prior to performing image compensation, and a projecting unit to project the separated color light components onto a screen.

To achieve at least the above and/or other aspects and advantage, embodiments of the present invention include an image compensating system. The system includes a receiving unit to receive information concerning overlapping components among color light components of a captured image, a separating unit to separate the color light components of an original image, prior to performing image compensation, by removing the overlapping components from the color light components of the original image based on the received information, and a projecting unit to project the separated color light components onto a screen.

To achieve at least the above and/or other aspects and advantage, embodiments of the present invention include an image compensating system. The system includes a capturing unit to capture the image projected onto the screen, a separating unit to separate color light components of a captured image by removing overlapping components among the color light components, prior to performing image compensation, and a transmitting unit to transmit an image composed of the separated color light components.

To achieve at least the above and/or other aspects and advantage, embodiments of the present invention include an image compensation method. The method includes extracting stored information concerning overlapping components among color light components of an original image, separating the color light components of the original image by removing the overlapping components from the color light components based on the extracted stored information, prior to performing image compensation, and projecting the separated color light components onto a screen.

To achieve at least the above and/or other aspects and advantage, embodiments of the present invention include an image compensation method. The method includes receiving information concerning overlapping components among color light components of a captured image, separating the color light components of an original image by removing the overlapping components from the color light components based on the received information, prior to performing image compensation, and projecting the separated color light components onto the screen.

To achieve at least the above and/or other aspects and advantage, embodiments of the present invention include an image compensation method. The method includes capturing an image projected onto a screen, separating color light components of the captured image by removing overlapping components among the color light components, prior to performing image compensation, and transmitting the captured image composed of the separated color light components.

To achieve at least the above and/or other aspects and advantage, embodiments of the present invention include an image compensation method. The method includes detecting information regarding overlapping spectral components among color light components of an image, and separating the overlapping spectral components from the color light components according to the detected information prior to performing image compensation on the image.

To achieve at least the above and/or other aspects and advantage, embodiments of the present invention include an image compensating system. The system includes a detecting unit to detect information regarding overlapping spectral components among color light components of an image, and a separating unit to separate the overlapping spectral components from the color light components according to the detected information prior to performing image compensation on the image.

### BRIEF DESCRIPTION OF THE DRAWINGS

The patent or application file contains at least one drawing executed in color. Copies of this patent or patent application publication with color drawings will be provided by the Office upon request and payment of the necessary fee. These and/or other aspects and advantages of the invention will become apparent and more readily appreciated from the following description of the embodiments, taken in conjunction with the accompanying drawings of which:

FIG. 1 illustrates color light components of an image captured by a camera according to the prior art;

FIGS. 2A to 2C illustrate color light components and overlapping components according to the prior art;

FIG. 3 illustrates an image compensating system, according an embodiment of the present invention;

FIG. 4 illustrates an image projecting apparatus, according to an embodiment of the present invention;

FIG. 5 illustrates an image projecting apparatus, according to an embodiment of the present invention;

FIG. 6 illustrates information concerning overlapping components detected by an image capturing apparatus, such as shown in FIG. 5, according to an embodiment of the present invention;

FIG. 7 illustrates color light components, such as projected by the image projecting apparatus shown in FIG. 5 after removing overlapping components, according to an embodiment of the present invention;

FIG. 8 illustrates an image capturing apparatus according, to an embodiment of the present invention;

FIG. 9 illustrates an image capturing apparatus, according to an embodiment of the present invention;

FIG. 10 is a flow chart representing an operating method, such as of the image projecting apparatus, according to an embodiment of the present invention;

FIG. 11 is a flow chart representing an operating method, such as of the image projecting apparatus, according to an embodiment of the present invention;

FIG. 12 is a flow chart representing an operating method, such as of the image capturing apparatus, according to an embodiment of the present invention; and

FIG. 13 is a flow chart representing an operating method, such as of the image capturing apparatus, according to the second embodiment of the present invention.

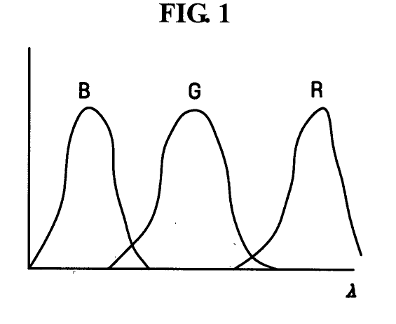

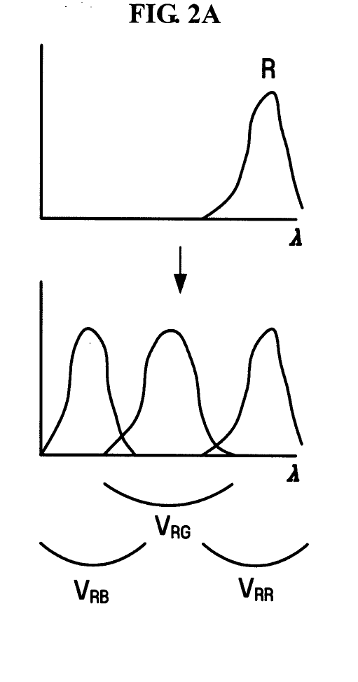

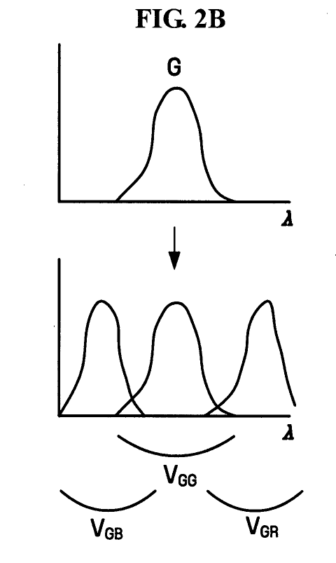

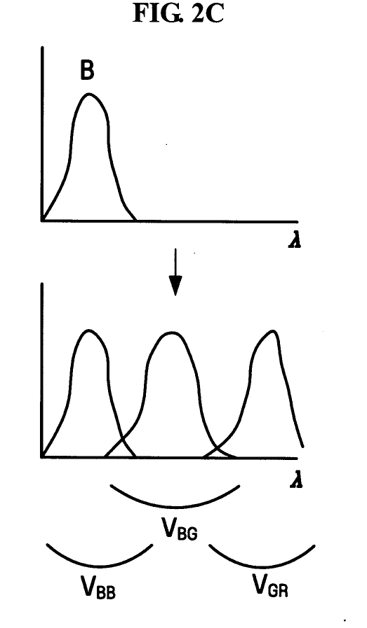

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

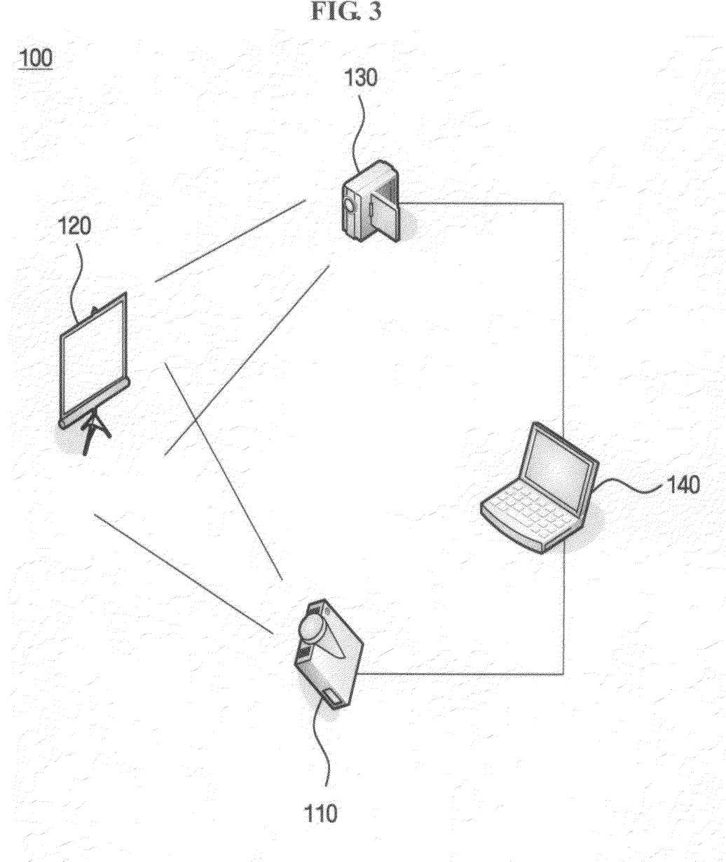

FIG. 3 is a view illustrating an image compensating system, according to an embodiment of the present invention.

As shown in FIG. 3, an image compensating system 100 according to an embodiment of the present invention may include an image projecting apparatus 110, a screen 120, an image capturing apparatus 130, and an image compensating apparatus 140, for example.

The image projecting apparatus 110 may receive an original input image from an image transmitting device connected thereto by a predetermined interface, and may project the original input image onto the screen 120. Examples of the interface for connecting between the image transmitting device and the image projecting apparatus 110 include Bluetooth, IEEE1394, and USB, but are not limited thereto.

In this embodiment, the image projecting apparatus 110 may be a projector. Examples of the image projecting apparatus 110 may include an LCD (Liquid Crystal Display) projector, a DLP (Digital Lighting Processing) projector, and a CRT (Cathode Ray Tube) projector, but are not limited thereto.

The image capturing apparatus 130 may capture the image projected onto the screen 120 by the image projecting apparatus 110 and transmit the captured image to the image compensating apparatus 140, e.g., a camera.

In an embodiment, the image projecting apparatus 110 and the image capturing apparatus 130 may be separately configured, but the present invention is not limited thereto. The image projecting apparatus 110 and the image capturing apparatus 130 may be integrated into a single apparatus, for example. In addition, the image projecting apparatus 110 and the image capturing apparatus 130 may be integrated into a mobile apparatus, as an example.

When the image capturing apparatus 130 captures the image projected onto the screen 120, the image compensating apparatus 140 may compare the color light components of the captured image to the color light components of the original image input to the image projecting apparatus 110 and perform image compensation.

In an embodiment, the image projecting apparatus 110, the image capturing apparatus 130, and the image compensating apparatus 140 may be separately configured. However, the present invention is not limited thereto. Alternatively, the image projecting apparatus 110, the image capturing apparatus 130, and the image compensating apparatus 140 may be integrated into a single apparatus, for example. In addition, the image projecting apparatus 110, the image capturing apparatus 130, and the image compensating apparatus 140 may be integrated into a mobile apparatus, for example.

When the image projecting apparatus 110 projects red, green, and blue light components of the original input image onto the screen 120, an image may be displayed on the screen 130 by a combination of the projected red, green, and blue light components. Even when the image projecting apparatus 110 separates the red, green, and blue light components and projects the separated red, green, and blue light components, the image captured by the image capturing apparatus 130 may include overlapping components of each color light component, with the other color light component having a wavelength adjacent thereto. These overlapping components may increase the amount of computation required to perform image compensation, when the image compensation is performed by comparing the color light components of the image captured by the image capturing apparatus 130, to the color light components of the original image input to the image projecting apparatus 110, for example. In other words, the image compensating apparatus 140 may perform image compensation based on the relationship between the original image input to the image projecting apparatus 110, and the image captured by the image capturing apparatus 130, and the image compensation may be performed using the following Expression 1.

$$\text{Expression 1:}$$

$$C = VP + E$$

$$C = [ \begin{matrix}{C}_{R} \\ {C}_{G} \\ {C}_{B}\end{matrix} ] , V = [ \begin{matrix}{V}_{RR} & {V}_{RG} & {V}_{RB} \\ {V}_{GR} & {V}_{GG} & {V}_{GB} \\ {V}_{BR} & {V}_{BG} & {V}_{BB}\end{matrix} ] , P = [ \begin{matrix}{P}_{R} \\ {P}_{G} \\ {P}_{B}\end{matrix} ] , E = [ \begin{matrix}{E}_{R} \\ {E}_{G} \\ {E}_{B}\end{matrix} ]$$

$$\{ \begin{matrix}{C}_{R} = {f}^{- 1} ( M ) \\ {C}_{G} = {f}^{- 1} ( M ) \\ {C}_{B} = {f}^{- 1} ( M )\end{matrix} , \{ \begin{matrix}{P}_{R} = p ( M ) \\ {P}_{G} = p ( M ) \\ {P}_{B} = p ( M )\end{matrix}$$

In Expression 1, C is a target image to be compensated, P is an image projected by the image projecting apparatus 110, V is a color mixing matrix, and E is environmental illumination and is obtained in a state of P=0, that is, in a state of projecting a black image. According to Expression 1, when the target image is compensated with respect to a predetermined color light component, not only the corresponding color light component but also the overlapping components of the corresponding color light component and the other color light components may be considered. In this case, the required amount of computation increases, which causes an increase in the time required for an apparatus, such as a mobile apparatus, having relatively low computing power to perform a computing process.

For this reason, in the image compensating system 100, according to an embodiment of the present invention, the image projecting apparatus 110 or the image capturing apparatus 130 may perfectly separate the color light components by removing the overlapping components existing among the color light components, for example. In doing so, it is possible to reduce the amount of computation required for the image compensating apparatus 140 to perform image compensation. In one or more embodiments of the present invention, the term “component” may be understood to denote a frequency or a wavelength, for example.

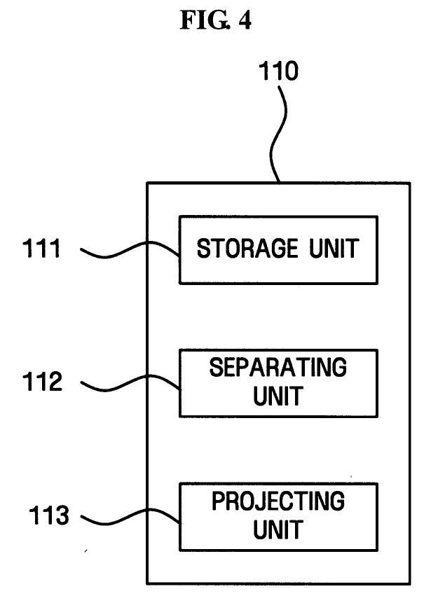

FIG. 4 illustrates an image projecting apparatus, according to a first embodiment of the present invention.

As shown in FIG. 4, an image projecting apparatus 110 according to a first embodiment of the present invention may include a storage unit 111 for storing information concerning overlapping components among color light components, a separating unit 112 for separating the color light components by removing the overlapping components from the color light components, and a projecting unit 113 for projecting the separated color light components onto the screen 120, for example.

The information concerning the overlapping components stored in the storage unit 111 may be set, for example, in the process of manufacturing the image compensating system 100, including the image projecting apparatus 110 according to an embodiment. The information may also be set by, for example, a manual or automatic update, or may be manually set by a user after shipment of the image compensating system 100. However, the present invention is not limited thereto. The information concerning each of the overlapping components among the color light components stored in the storage unit 111 may include a frequency or a wavelength corresponding to the corresponding overlapping component, for example.

The separating unit 112 may separate the color light components by removing the overlapping components from the color light components of the original image, based on the stored information concerning the overlapping components, using a dichroic filter or a dichroic mirror, for example.

The separating unit 112 may include a dichroic filter or a dichroic mirror, for example. In an LCD projector, the separating unit may be provided on a liquid crystal panel projecting color light components onto the screen 120, for example. In a DLP projector, the separating unit may be provided on a DMD (Digital Mirror Device), for example. The above-mentioned structure and a disposing method of the separating unit are just illustrative examples, and the present invention is not limited thereto. The structure and position of the separating unit 112 may be modified according to use or necessity.

The projecting unit 113 may project, e.g.,onto the screen 120 the color light components separated by removing the overlapping components. The above-mentioned image capturing apparatus 130 may capture the image projected by the projecting unit 113 and transmit the captured image to the image compensating apparatus 140 for image compensation.

As described above, the image projecting apparatus 110 may project the image composed of the separated color light components. Therefore, the image compensating apparatus 140 may perform image compensation with respect to only the color components V_{RR}, V_{GG}, and V_{BB}, except for, potentially, the overlapping components of V of Expression 1. As a result, the amount of computation required for image compensation may be reduced.

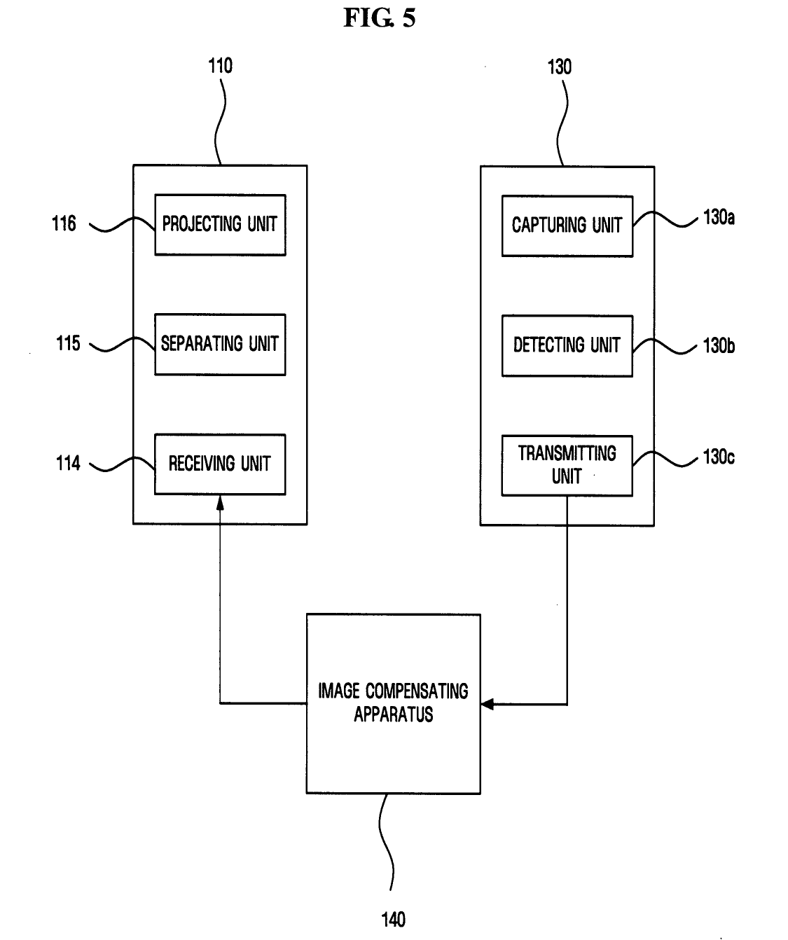

FIG. 5 illustrates an image projecting apparatus, according to a second embodiment of the present invention. FIG. 5 shows an example in which the image projecting apparatus 110 may not store information concerning overlapping components and may remove overlapping components detected by the image capturing apparatus 140, in contrast to the example shown in FIG. 4.

As shown in FIG. 5, an image projecting apparatus 110 according to a second embodiment of the present invention may include a receiving unit 114 receiving information concerning overlapping components existing among color light components from the image capturing apparatus 130, a separating unit 115 separating the color light components by removing the overlapping components from the original image based on the received information, and a projecting unit 116 projecting the separated color light components onto a screen 120, for example.

When the image capturing apparatus 130 captures the image projected onto the screen 120, analyzes the color light components of the captured image, and outputs, as the analysis result, information concerning overlapping components among the color light components, the receiving unit 114 may receive and store the information concerning the overlapping components. The received information concerning the overlapping components may include at least one of a frequency and a wavelength corresponding to each overlapping component, for example.

The separating unit 115 may separate the color light components by removing the overlapping components from the color light components of the original image based on the received information concerning the overlapping components. The projecting unit 116 may project the color light components separated by the separating unit 115, onto the screen 120. The separated color light components projected by the projecting unit 116 may be color light components obtained by removing the overlapping components from the original image by the separating unit 115, for example.

The image capturing apparatus 130 for transmitting information concerning overlapping components, according to a second embodiment of the present invention may include a capturing unit 130a for capturing an image projected onto the screen 120, a detecting unit 130b for detecting overlapping components from the color light components of the captured image, and a transmitting unit 130c for transmitting information concerning the detected overlapping components to the image compensating apparatus 140, for example.

When the image projecting apparatus 110 projects the original input image onto the screen 120, the capturing unit 130a may capture the projected image and the detecting unit 130b may detect overlapping components from the color light components of the captured image. The detected overlapping component may be a wavelength or a frequency, for example.

The transmitting unit 130c may transmit the information concerning the detected overlapping components to the image compensating apparatus 140, and the image compensating apparatus 140 may transmit the information concerning the overlapping components to the image projecting apparatus 110. The separating unit 115 of the image projecting apparatus 110 may remove the overlapping components from the color light components based on the information concerning the overlapping components transmitted from the image compensating apparatus 140, for example.

Therefore, the image compensating apparatus 140 may perform image compensation with respect to the components V_{RR}, V_{GG}, and V_{BB}, except for, potentially, the overlapping components, of V of Expression 1. As a result, the amount of computation required for image compensation may be reduced.

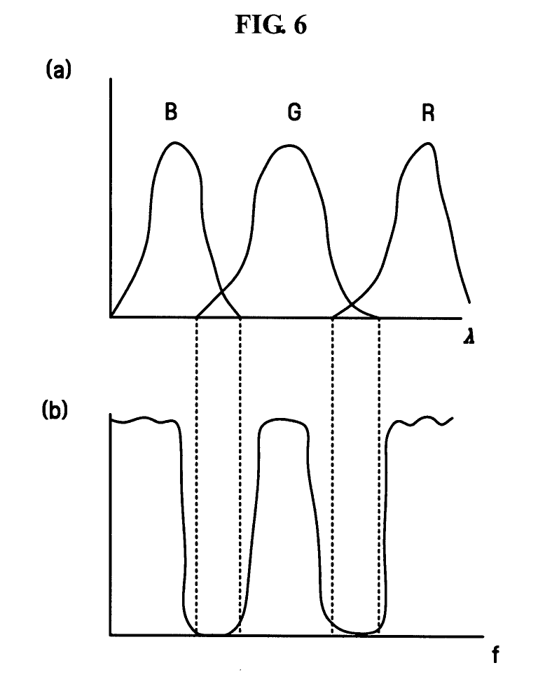

More specifically, the image captured by the image capturing apparatus 130 shown in FIG. 5 may have overlapping components among the color light components R, G, and B, as shown in (A) of FIG. 6. The image capturing apparatus 130 may detect the overlapping components from the image projected by the image projecting apparatus 110 and transmit information concerning the detected overlapping components (for example, frequencies or wavelengths corresponding to the overlapping components) to the image compensating apparatus 140. The overlapping components may be removed according to the detection result such that the overlapping components are not transmitted, as shown in (B) of FIG. 6.

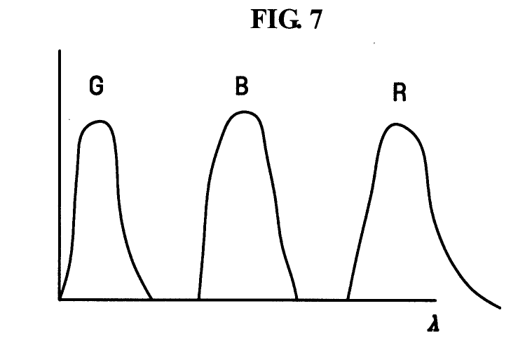

The image projecting apparatus 110 may receive the information concerning the overlapping components from the image compensating apparatus 140, separate the color light components of the image received from the image capturing apparatus 130 by removing the overlapping components based on the information concerning the overlapping components, as shown in FIG. 7, and project the separated color light components R, G, and B onto the screen 120. Since the overlapping components may be removed from the color light components, the color light components may be perfectly separated.

Further, since the overlapping components of a predetermined color light component are removed, the image compensation may be performed with respect to only the components V_{RR}, V_{GG}, and V_{BB}, except for, potentially, the overlapping components of Expression 1.

In the image projecting apparatus 110, the separating unit 115 used for removing the overlapping components may include a dichroic filter or a dichroic mirror, for example. In an LCD projector, the separating unit may be provided on a liquid crystal panel for projecting color light components onto the screen 120, for example. In a DLP projector, the separating unit may be provided on a DMD (Digital Mirror Device), for example. The above-mentioned structure and disposing method of the separating unit are merely illustrative examples and the present invention is not limited thereto. The structure and position of the separating unit 112 may be modified according to use or necessity.

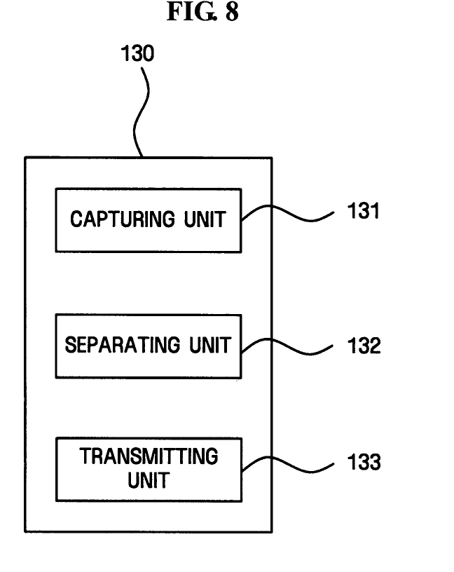

FIG. 8 illustrates an image capturing apparatus according to a first embodiment of the present invention. FIG. 8 shows an example in which the image capturing apparatus 130 may remove the overlapping components from the color light components, in contrast to the examples shown in FIGS. 4 and 5.

As shown in FIG. 8, an image capturing apparatus 130, according to a first embodiment of the present invention may include a capturing unit 131 for capturing an image projected onto a screen 120 using an image projecting apparatus 110, a separating unit 132 for separating the color light components by removing overlapping components from the color light components of the captured image based on information concerning overlapping components received from the image projecting apparatus 110, and a transmitting unit 133 for transmitting the image composed of the separated color light components to an image compensating apparatus 140, for example.

The separating unit 132 may receive the information concerning overlapping components among color light components stored in advance and may separate the color light components by removing the overlapping components from the captured image based on the received information, similar to the image projecting apparatus 110 shown in FIG. 4. The received information may include at least one of a frequency and a wavelength corresponding to each overlapping component. The separating unit 132 may remove the overlapping components by using, for example, at least one of a dichroic filter and a dichroic mirror disposed on the path of each color light component from the capturing unit 131.

The transmitting unit 133 may transmit the image composed of the color light components, separated by the separating unit 132, to the image compensating apparatus 140.

Therefore, the image compensating apparatus 140 need only perform image compensation for the components V_{RR}, V_{GG}, and V_{BB}, except for, potentially, the overlapping components, of Expression 1.

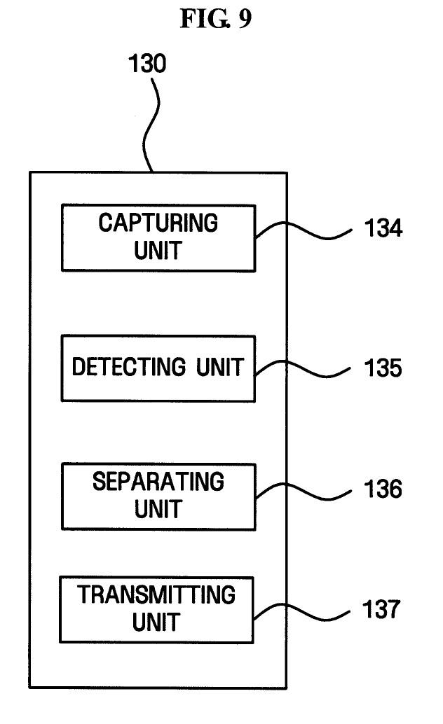

FIG. 9 illustrates an image capturing apparatus, according to a second embodiment of the present invention. FIG. 9 shows an example in which the image capturing apparatus 130 may detect overlapping components from color light components of an image, captured by itself, without receiving information concerning overlapping components from the image projecting apparatus 110, and may remove the detected overlapping components, in contrast to the example shown in FIG. 8.

As shown in FIG. 9, an image capturing apparatus 130, according to a second embodiment of the present invention, may include a capturing unit 134 for capturing an image projected onto a screen 120, a detecting unit 135 for detecting overlapping components from the color light components of the captured image, a separating unit 136 for separating the color light components by removing the detected overlapping components from the color light components, and a transmitting unit 137 for transmitting an image composed of the separated color light components to an image compensating apparatus 140 for image compensation, for example.

The detecting unit 135 may detect the overlapping components from the color light components of the captured image by analyzing, e.g., the frequencies or wavelengths of the color light components. The separating unit 136 may separate the color light components by removing the detected overlapping components from the color light components of the captured image. The separating unit 136 may remove the overlapping components by using, for example, at least one of a dichroic filter or a dichroic mirror disposed on the path of each color light component from the capturing unit 134.

The transmitting unit 137 may transmit the image composed of the color light components separated by the separating unit 136 to the image compensating apparatus 140.

Since the image capturing apparatus 130, such as shown in FIG. 9, removes the overlapping components, the image compensating apparatus 140 need only perform image compensation for the components V_{RR}, V_{GG}, and V_{BB}, except for, potentially, the overlapping components of Expression 1.

In one or more embodiments of the present invention, an example in which the image projecting apparatus 110 separates the color light components and an example in which the image capturing apparatus 130 separates the color light components have been separately described. However, the present invention is not limited thereto. Both the image projecting apparatus 110 and the image capturing apparatus 130 may separate the color light components. In other words, the components of FIGS. 4, 5, 8, and 9 may be selectively combined.

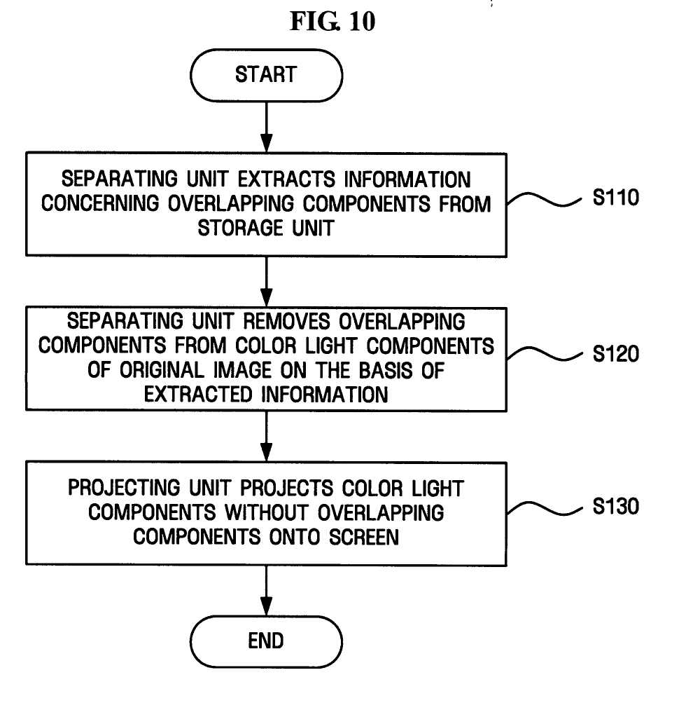

FIG. 10 illustrates an operating method, such as of the image projecting apparatus, according to an embodiment of the present invention. FIG. 10 shows an example of the operation of the image projecting apparatus 110, such as the one shown in FIG. 4.

As shown in FIG. 10, in the operating method, according to an embodiment of the present invention, the separating unit 112 may extract information concerning overlapping components from the storage unit 111, in operation S110. The extracted information concerning overlapping components may be set in the process of manufacturing the image projecting apparatus, or by update or by a user after manufacturing the image projecting apparatus, for example.

The separating unit 112 may separate the color light components by removing the overlapping component from the color light components of the original image based on the extracted information, in operation S120. The removal of the overlapping components from the color light components is performed, for example, to reduce the amount of computation required for image compensation.

The projecting unit 113 may project, e.g., onto the screen 120, the color light components separated by the separating unit 112, in operation S130. The image capturing apparatus 130 may capture the image composed of the projected color light components, and the image compensating apparatus 140 may compare the captured image to the original image to perform image compensation.

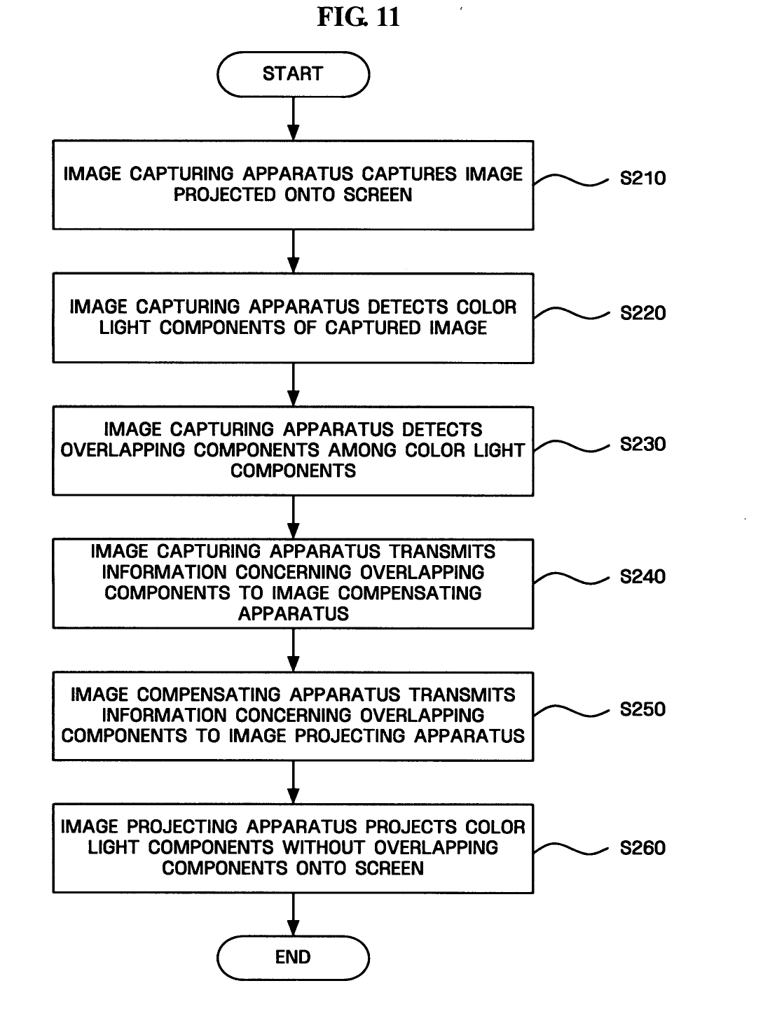

FIG. 11 illustrates an operating method, such as of the image projecting apparatus, according to a second embodiment of the present invention. FIG. 11 shows an example of the operation of the image projecting apparatus 110 and the image capturing apparatus 130, examples of which are shown in FIG. 5.

As shown in FIG. 11, in the operating method, such as of the image projecting apparatus according to a second embodiment of the present invention, the image capturing apparatus 130 may capture an image projected onto the screen 120, in operation S210. More specifically, the capturing unit 130a, of the image capturing apparatus 130, may capture the image projected onto the screen 120. Since the removing of overlapping components has not yet been performed, the captured image may include overlapping components among the color light components.

The detecting unit 130b may detect the color light components from the image captured by the capturing unit 130a, in operation S220, and may detect the overlapping components among the color light components, in operation S230. When the image compensating apparatus 140 performs image compensation using Expression 1, the overlapping components are also considered and accordingly, the amount of computation may increase. However, in the current embodiment, as described above, information about the overlapping components may be detected and transmitted to the image projecting apparatus 110 and an image without the transmitted overlapping components may be projected. When the overlapping components are removed, the amount of computation required for the image compensating apparatus 140 to perform image compensation may be reduced.

The transmitting unit 130c may transmit the information concerning the overlapping components detected by the detecting unit 130b to the image compensating apparatus 140, in operation S240, and the image compensating apparatus 140 may transmit the received information concerning the overlapping components to the image projecting apparatus 110, in operation S250.

In the image projecting apparatus 110, the receiving unit 114 may receive the transmitted information concerning the overlapping components, the separating unit 115 may perfectly separate the color light components by removing the overlapping components, and the projecting unit 116 may project the separated color light components, e.g., onto the screen 120, in operation S260.

In the operating method, such as of the image projecting apparatus, according to a second embodiment of the present invention, after removing the overlapping components from the color light components of the original input image, the image projecting apparatus 110 may project the image without the overlapping components onto, e.g., the screen 120. Therefore, when the image compensating apparatus 140 performs compensation on the projected image or the image captured by the image capturing apparatus 130 by Expression 1, only the components V_{RR}, V_{GG}, and V_{BB} of Expression 1 may be considered and thus the required amount of computation may be reduced. As a result, even though the image compensating apparatus may have little computing power such as a mobile apparatus, the computing efficiency may be improved since the amount of required computation may be reduced.

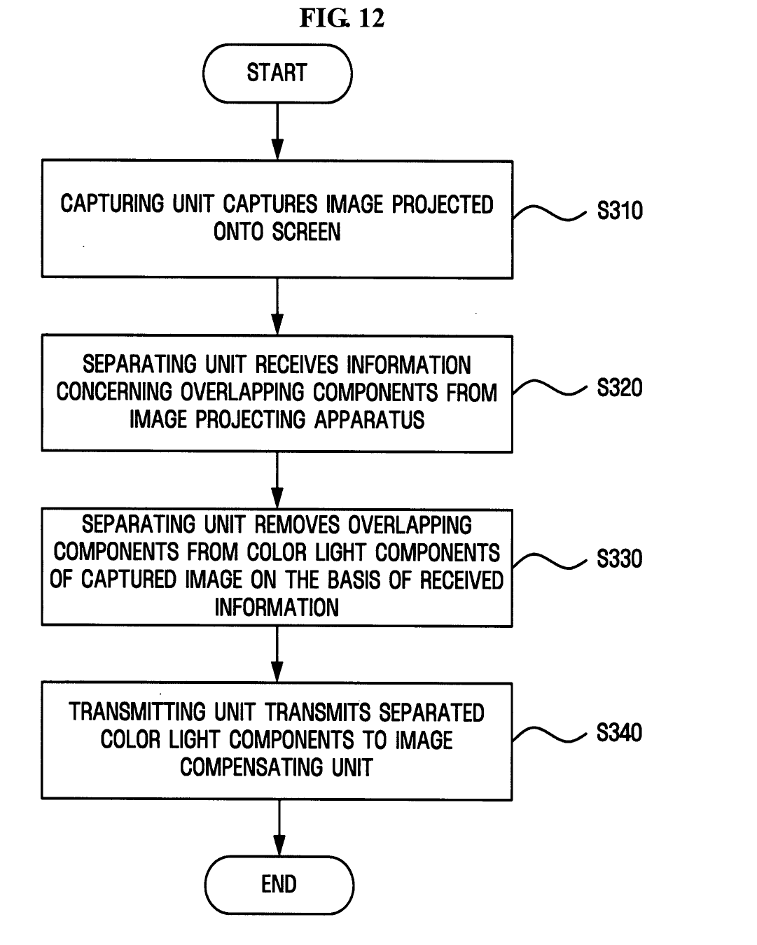

FIG. 12 illustrates an operating method, such as of the image capturing apparatus, according to a first embodiment of the present invention. FIG. 12 shows an example of the operation of the image capturing apparatus 130, shown in FIG. 8.

As shown in FIG. 12, in the operating method, according to a first embodiment, the capturing unit 131 may capture an image projected onto, e.g., the screen 120, by the image projecting apparatus 110, in operation S310. Since the removing of overlapping components has not yet been performed, the captured image may have overlapping components among the color light components.

The separating unit 132 may receive information concerning the overlapping components from the image projecting apparatus 110, in operation S320. The received information concerning the overlapping components from the image projecting apparatus 110 may have been stored in the image projecting apparatus 110 in advance as described above in the description of FIG. 4.

The separating unit 132 may separate the color light components of the captured image by removing the overlapping components detected among the color light components based on the received information, in operation S330.

The transmitting unit 133 may transmit the image without the overlapping components to the image compensating apparatus 140, in operation S340.

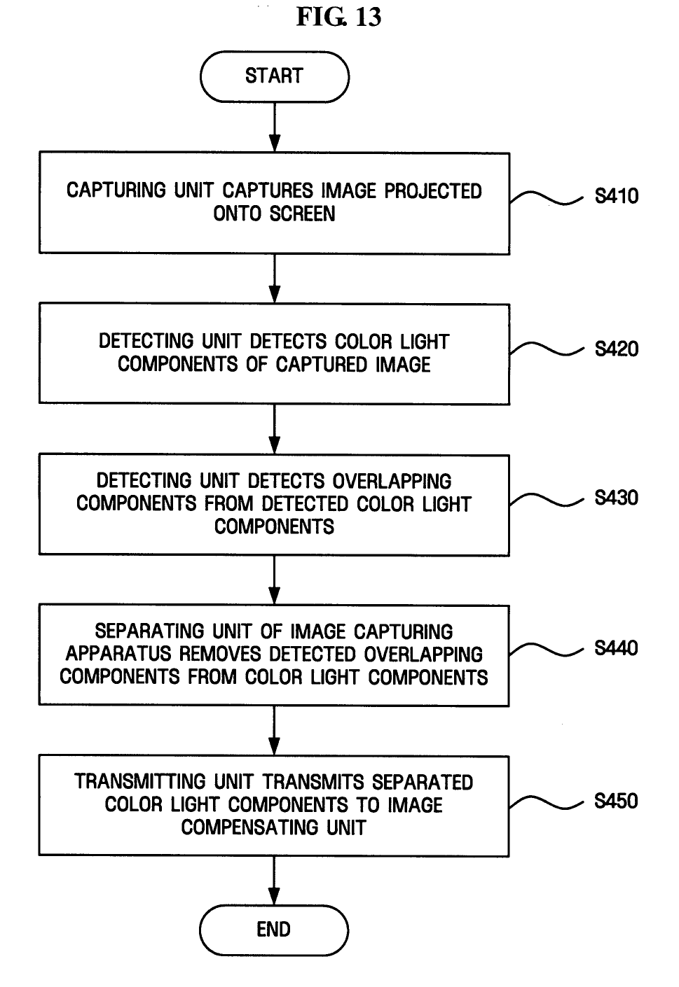

FIG. 13 illustrates an operating method, such as of an image capturing apparatus, according to a second embodiment of the present invention. FIG. 13 shows an example of the operation of the image capturing apparatus 130 shown in FIG. 9.

As shown in FIG. 13, in the operation method, such as of the image capturing apparatus, according to a second embodiment, the image capturing apparatus 130 may capture an image projected, e.g., onto the screen 120, by the image projecting apparatus 110, in operation S410. More specifically, when the capturing unit 134 of the image capturing apparatus 130 captures the image projected, e.g., onto the screen 120, the capturing unit 134 may capture the color light components of the image. Since the removal of overlapping components has not yet been performed, the captured image may include overlapping components among the color light components.

The detecting unit 135 may detect, e.g., frequencies or wavelengths of the color light components of the image captured by the capturing unit 134 in operation S420, and may detect the overlapping components among the detected color light components, in operation S430. When the image compensating apparatus 140 performs image compensation using Expression 1, the overlapping components may also be considered and accordingly, the amount of necessary computation may increase. However, in this embodiment, as described above, the overlapping components may be detected and transmitted to the image projecting apparatus 110, and an image without the transmitted overlapping components may be projected. Since the overlapping components have been removed, it is possible to reduce the amount of computation required for the image compensating apparatus 140 to perform image compensation.

The separating unit 136 may perfectly separate the color light components by removing the overlapping components detected by the detecting unit 135 from the color light components of the captured image, in operation S440.

The transmitting unit 137 may transmit the color light components without the overlapping components to the image compensating apparatus 140 for image compensation, in operation S450.

Then, the image compensating apparatus 140 may receive the color light components from the image capturing apparatus 130 and may perform image compensation while considering only the components V_{RR}, V_{GG}, and V_{BB}, except for, potentially, the overlapping components of Expression 1. Therefore, it is possible to reduce the amount of computation required for the image compensation.

The term “unit,” as used herein, may mean, but is not limited to, a software or hardware component, such as a Field Programmable Gate Array (FPGA) or an Application Specific Integrated Circuit (ASIC), which performs certain tasks. A unit may advantageously be configured to reside on an addressable storage medium and configured to be executed on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, elements and units may be implemented to be executed on one or more CPUs within a device or to reside on a secure multimedia card.

One or more embodiments of the present invention have also been described herein with reference to block diagrams or flowchart illustrations of an image compensating system, method and medium. Each block of the flowchart illustrations, and combinations of blocks in the flowchart illustrations may be implemented by computer program instructions. These computer program instructions may be provided to a processor, e.g., of a general purpose computer, special purpose computer, or other programmable data processing apparatus to produce a machine, such that the instructions, which execute via the processor of the computer or other programmable data processing apparatus, create techniques for implementing the functions specified in the flowchart block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus implement the functions specified in the flowchart block or blocks.

And each block of the block diagrams may represent a module, segment, or portion of code, which include one or more executable instructions for implementing the specified logical function(s). In alternative implementations, the functions noted in the blocks may occur out of order. For example, two blocks shown in succession may in fact be executed substantially concurrently or the blocks may sometimes be executed in reverse order depending upon the functionality involved.

In addition to this discussion, one or more embodiments of the present invention may also be implemented through such software as computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to one or more embodiments of the present invention. The media may also be a distributed network, so that the computer readable code is stored/transferred and executed in a distributed fashion. Still further, as only an example, the processing element may include a processor or a computer processor, and processing elements may be distributed and/or included in a single device.

In the image compensating system, method and medium, according to one or more embodiments of the present invention, it is possible to perfectly separate color light components by removing overlapping components from the color light components of an original image, and of an image captured by projecting the original image onto a screen. Accordingly, it is possible to reduce the amount of computation required to perform the image compensation.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image compensating system, comprising:
a storage unit to store information concerning overlapping components among color light components;
a separating unit to separate the color light components of an original image by removing the overlapping components from the color light components based on the stored information, prior to performing image compensation; and
a projecting unit to project the separated color light components onto a screen.

2. The system of claim 1, wherein the information concerning the overlapping components comprises at least one of a frequency and a wavelength corresponding to each overlapping component.

3. The system of claim 1, wherein the separating unit comprises at least one of a dichroic filter and a dichroic mirror to remove the overlapping components from the color light components of the original image.

4. The system of claim 1, further comprising a compensating unit to compare a captured image to the original image without the overlapping components to perform the image compensation.

5. An image compensating system, comprising:
a receiving unit to receive information concerning overlapping components among color light components of a captured image;
a separating unit to separate the color light components of an original image, prior to performing image compensation, by removing the overlapping components from the color light components of the original image based on the received information; and
a projecting unit to project the separated color light components onto a screen.

6. The system of claim 5, wherein the information concerning the overlapping components comprises at least one of a frequency and a wavelength corresponding to each overlapping component.

7. The system of claim 5, wherein the separating unit comprises at least one of a dichroic filter and a dichroic mirror to remove the overlapping components from the color light components of the original image.

8. The system of claim 5, further comprising a compensation unit to perform image compensation by comparing a captured image to the original image without the overlapping components.

9. An image compensating system, comprising:
a capturing unit to capture the image projected onto the screen;
a separating unit to separate color light components of a captured image by removing overlapping components among the color light components, prior to performing image compensation; and
a transmitting unit to transmit an image composed of the separated color light components.

10. The system of claim 9, wherein the separating unit receives information concerning the overlapping components, and removes the overlapping components based on the received information.

11. The system of claim 10, wherein the information concerning the overlapping components comprises at least one of a frequency and a wavelength corresponding to each overlapping component.

12. The system of claim 9, further comprising a detecting unit to detect the overlapping components from the color light components of the captured image.

13. The system of claim 12, wherein the separating unit removes the overlapping components from the color light components of the captured image based on the detected overlapping components.

14. The system of claim 13, wherein the detected overlapping components comprises at least one of a frequency and a wavelength corresponding to each overlapping component.

15. The system of claim 9, wherein the separating unit comprises at least one of a dichroic filter and a dichroic mirror to remove the overlapping components from the color light components of the image.

16. The system of claim 9, further comprising a compensation unit to perform image compensation by comparing an original image to the captured image having the separated color light components.

17. An image compensation method, comprising:
extracting stored information concerning overlapping components among color light components of an original image;
separating the color light components of the original image by removing the overlapping components from the color light components based on the extracted stored information, prior to performing image compensation; and
projecting the separated color light components onto a screen.

18. The method of claim 17, wherein the information concerning the overlapping components comprises at least one of a frequency and a wavelength corresponding to each overlapping component.

19. The method of claim 17, wherein the separating of the color light components comprises removing the overlapping components from the color light components of the original image using at least one of a dichroic filter and a dichroic mirror.

20. The method of claim 17, further comprising comparing the original image composed of the separated color light components to an image captured from the separated color light components projected onto the screen.

21. An image compensation method, comprising:
receiving information concerning overlapping components among color light components of a captured image;
separating the color light components of an original image by removing the overlapping components from the color light components based on the received information, prior to performing image compensation; and
projecting the separated color light components onto the screen.

22. The method of claim 21, wherein the information concerning the overlapping components comprises at least one of a frequency and a wavelength corresponding to each overlapping component.

23. The method of claim 21, wherein the separating of the color light components comprises removing the overlapping components from the color light components of the original image using at least one of a dichroic filter and a dichroic mirror.

24. The method of claim 21, further comprising comparing the captured image to the original image composed of the separated color light components.

25. An image compensation method, comprising:
capturing an image projected onto a screen;
separating color light components of the captured image by removing overlapping components among the color light components, prior to performing image compensation; and
transmitting the captured image composed of the separated color light components.

26. The method of claim 25, wherein the separating of the color light components comprises:
receiving information concerning the overlapping components; and
removing the overlapping components based on the received information.

27. The method of claim 26, wherein the information concerning the overlapping components comprises at least one of a frequency and a wavelength corresponding to each overlapping component.

28. The method of claim 25, further comprising detecting information regarding the overlapping components among the color light components of the captured image.

29. The method of claim 28, wherein the separating of the color light components comprises removing the overlapping components from the color light components of the captured image based on the detected information.

30. The method of claim 29, wherein the detected information comprises at least one of a frequency and a wavelength corresponding to each of the overlapping components.

31. The method of claim 25, wherein the separating of the color light components comprises removing the overlapping components from the color light components of the captured image using at least one of a dichroic filter and a dichroic mirror.

32. The method of claim 25, further comprising comparing the captured image to an original image composed of the separated color light components.

33. At least one medium comprising computer readable code to control at least one processing element to implement the method of claim 25.

34. An image compensation method, comprising:
detecting information regarding overlapping spectral components among color light components of an image; and
separating the overlapping spectral components from the color light components according to the detected information prior to performing image compensation on the image.

35. The method of claim 34, wherein the detected information comprises at least one of a frequency and a wavelength corresponding to each of the overlapping spectral components.

36. The method of claim 34, wherein the separating of the overlapping spectral components comprises removing the overlapping components from the color light components of the captured image using at least one of a dichroic filter and a dichroic mirror.

37. At least one medium comprising computer readable code to control at least one processing element to implement the method of claim 34.

38. An image compensating system, comprising:
a detecting unit to detect information regarding overlapping spectral components among color light components of an image; and
a separating unit to separate the overlapping spectral components from the color light components according to the detected information prior to performing image compensation on the image.

39. The system of claim 38, wherein the detected overlapping spectral components comprises at least one of a frequency and a wavelength corresponding to each overlapping component.

40. The system of claim 38, wherein the separating unit further comprises at least one of a dichroic filter and a dichroic mirror to remove the overlapping components from the color light components of the image.
